(19) United States
(12) Patent Application Publication
(10) Pub. No.: US 2022/0046096 A1
(43) Pub. Date: Feb. 10, 2022

(54) Vehicle Communication System And Corresponding Method

(71) Applicant: Ford Global Technologies, LLC, Dearborn, MI (US)

(72) Inventors: Chao LU, Shanghai (CN); Calvin Zhou, Shanghai (CN)

(21) Appl. No.: 17/397,704

(22) Filed: Aug. 9, 2021

(30) Foreign Application Priority Data
Aug. 10, 2020 (CN) 2020107941745

(51) Int. Cl. H04L 29/08; G16Y 10/75; G16Y 10/40

(52) U.S. Cl. CPC H04L 67/12; G16Y 10/40; G16Y 10/75; H04L 67/306

(57) ABSTRACT

The present disclosure provides a vehicle communication system, comprising: an information processing device including a processor and a memory. The memory stores instructions executable by the processor, that, when executed by the processor, cause the processor to perform steps comprising: in response to reception of a message sent by an Internet of Things device, determining category of the message and obtaining a corresponding user profile; and in response to the message being of a preset category, feeding real-time vehicle information back to the Internet of Things device based on the user profile. The present disclosure also provides a vehicle communication system and method. According to the present disclosure, an Internet of Things device, such as those in a house, can send a request to a vehicle and conveniently obtain the corresponding vehicle information without causing excessive interference to the driving driver.

### CROSS-REFERENCE TO RELATED APPLICATIONS

The present disclosure claims priority to and the benefit of Chinese patent application No. 2020107941745, filed Aug. 10, 2020, which is hereby incorporated by reference herein in its entirety.

### FIELD

The present disclosure generally relates to the field of vehicles, and more specifically, to a vehicle communication system and a corresponding method.

### BACKGROUND

In daily use of a vehicle, when a person in a place such as a house or a company wants to communicate with a driver in the vehicle, he usually sends a communication request to the vehicle computer or the driver's mobile device via a mobile device. At present, with the further development of communication technology, such as the popularization of fifth-generation communication technology (5G), more and more Internet of Things devices provide people with richer communication possibilities.

In the United States Patent Publication U.S. Pat. No. 9,378,601B2, a method is proposed, which includes implementing the following steps through a home automation system: determining that a person has entered a home associated with a vehicle user; sending an alert to a vehicle control system indicating the person has entered the home; monitoring a status of the person in the home; determining that the status of the person has changed; sending a status alert to the vehicle control system; including in the status alert when the person cannot be identified an intruder alert; including in the status alert when the person is leaving the home one of an estimated time the person will leave the home and the time the person has left the home; including in the status alert when the person is asleep that the person is asleep; including in the status alert when the person is experiencing a health crisis information about the health crisis; and including in the status alert when the person has entered an area of the home the person is not authorized to enter the information about the location in the home of the person. In the current solutions, many of them am aimed at obtaining information in the houses through vehicles or instructing the Internet of Things devices in the houses to perform corresponding operations.

However, these existing solutions do not consider more from the perspective of the Internet of Things devices obtaining information from the vehicles and inventors of the present disclosure recognize that such application scenarios may actually occur frequently.

### SUMMARY

The present disclosure summarizes aspects of the embodiments and should not be used to limit the claims. Other implementations are contemplated in accordance with the techniques described herein, as will be apparent to those of ordinary skill in the art upon examination of the following drawings and detailed description, and such implementations are intended to be within the scope of this application.

The inventors of the present disclosure recognize that there is a need for a vehicle communication system and a corresponding method that can enable an Internet of Things device, such as those in a house, to send a request to a vehicle and conveniently obtain the corresponding vehicle information without causing excessive interference to the driving driver.

According to an aspect of the present disclosure, there is provided a vehicle communication system, comprising:
an information processing device including a processor and a memory, the memory storing instructions executable by the processor, that, when executed by the processor, cause the processor to perform steps comprising:
   in response to reception of a message sent by an Internet of Things device, determining category of the message and obtaining a corresponding user profile; and
   in response to the message being of a preset category, feeding real-time vehicle information back to the Internet of Things device based on the user profile.
According to an embodiment of the present disclosure, feeding real-time vehicle information back to the Internet of Things device based on the user profile further comprises:
in response to inclusion of asking permission before feeding back in the user profile, asking a driver whether he agrees to feed the real-time vehicle information back to the Internet of Things device; and
if the driver agrees, feeding the real-time vehicle information back to the Internet of Things device.

According to an embodiment of the present disclosure, feeding real-time vehicle information back to the Internet of Things device based on the user profile further comprises:
in response to designation of a number of trusted devices in the user profile, determining whether the Internet of Things device belongs to the trusted device; and
if the Internet of Things device belongs to the trusted device, directly feeding the real-time vehicle information back to the Internet of Things device.

According to an embodiment of the present disclosure, the steps further comprise:
if the Internet of Things device does not belong to the trusted device, asking the driver whether he agrees to feed the real-time vehicle information back to the Internet of Things device, and
if the driver agrees, feeding the real-time vehicle information back to the Internet of Things device.

According to an embodiment of the present disclosure, the steps further comprise:
in response to the message being a voice message, asking the driver whether to listen to the message; and
if the driver confirms to listen to the message, playing the message to the driver.

According to an embodiment of the present disclosure, the steps further comprise:
in response to the reception of the message sent by an Internet of Things device, confirming connection status of the vehicle; and
in response to confirmation that the vehicle is not connected, retaining the message and forwarding the message to the vehicle the next time the vehicle is connected.

According to an embodiment of the present disclosure, the steps further comprise:
in response to confirmation that the vehicle is not connected, sending a notification to the Internet of Things device.

According to an embodiment of the present disclosure, feeding real-time vehicle information back to the Internet of Things device based on the user profile further comprises:
retrieving and analysing current location, speed, regional traffic conditions, and usual schedule of the vehicle to determine an estimated time-of-arrival of the vehicle; and
feeding the estimated time-of-arrival of the vehicle back to the Internet of Things device.

According to an aspect of the present disclosure, there is provided a vehicle communication method, comprising:
in response to reception of a message sent by the Internet of Things device, determining category of the message and obtaining a corresponding user profile; and
in response to the message being of a preset category, feeding real-time vehicle information back to the Internet of Things device based on the user profile.

According to an embodiment of the present disclosure, feeding real-time vehicle information back to the Internet of Things device based on the user profile further comprises:
in response to inclusion of asking permission before feeding back in the user profile, asking a driver whether he agrees to feed the real-time vehicle information back to the Internet of Things device; and
if the driver agrees, feeding the real-time vehicle information back to the Internet of Things device.

According to an embodiment of the present disclosure, feeding real-time vehicle information back to the Internet of Things device based on the user profile further comprises:
in response to designation of a number of trusted devices in the user profile, determining whether the Internet of Things device belongs to the trusted device; and
if the Internet of Things device belongs to the trusted device, directly feeding the real-time vehicle information back to the Internet of Things device.

According to an embodiment of the present disclosure, the method further comprises:
if the Internet of Things device does not belong to the trusted device, asking the driver whether he agrees to feed the real-time vehicle information back to the Internet of Things device; and
if the driver agrees, feeding the real-time vehicle information back to the Internet of Things device.

According to an embodiment of the present disclosure, the method further comprises:
In response to the message being a voice message, asking the driver whether to listen to the message; and
if the driver confirms to listen to the message, playing the message to the driver.

According to an embodiment of the present disclosure, feeding real-time vehicle information back to the Internet of Things device based on the user profile further comprises:
retrieving and analysing current location, speed, regional traffic conditions, and usual schedule of the vehicle to determine an estimated time-of-arrival of the vehicle; and
feeding the estimated time-of-arrival of the vehicle back to the Internet of Things device.

According to an aspect of the present disclosure, there is provided a vehicle communication system, comprising:
an Internet of Things device;
a vehicle computer; and
a cloud server including a processor and a memory, the memory storing instructions executable by the processor, that, when executed by the processor, cause the processor to perform steps comprising:
   in response to reception of a message sent by the Internet of Things device, determining category of the message and connection status of the corresponding vehicle computer and obtaining a corresponding user profile; and
   in response to the connection status being connected status and the message being of a preset category, feeding real-time vehicle information obtained from the vehicle computer back to the Internet of Things device based on the user profile.

According to an embodiment of the present disclosure, feeding real-time vehicle information obtained from the vehicle computer back to the Internet of Things device based on the user profile further comprises:
in response to inclusion of asking permission before feeding back in the user profile, asking the driver whether he agrees to feed the real-time vehicle information back to the Internet of Things device; and
if the driver agrees, feeding the real-time vehicle information back to the Internet of Things device.

According to an embodiment of the present disclosure, feeding real-time vehicle information obtained from the vehicle computer back to the Internet of Things device based on user profile further comprises:
in response to designation of a number of trusted devices in the user profile, determining whether the Internet of Things device belongs to the trusted device; and
if the Internet of Things device belongs to the trusted device, directly feeding the real-time vehicle information back to the Internet of Things device.

According to an embodiment of the present disclosure, the steps further comprise:
if the Internet of Things device does not belong to the trusted device, asking the driver whether he agrees to feed the real-time vehicle information back to the Internet of Things device; and
if the driver agrees, feeding the real-time vehicle information back to the Internet of Things device.

According to an embodiment of the present disclosure, the steps further comprise:
in response to confirmation that the vehicle computer is not connected, retaining the message and forwarding the message to the vehicle computer the next time the vehicle computer is connected.

According to an embodiment of the present disclosure, the steps further comprise:
in response to the message being a voice message, asking the driver whether to listen to the message; and
if the driver confirms to listen to the message, playing the message to the driver.

### BRIEF DESCRIPTION OF THE DRAWINGS

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the figures, like referenced numerals may refer to like parts throughout the different figures.

FIG. 1 shows a schematic diagram of a vehicle communication system according to an embodiment of the present disclosure;

FIG. 2 shows a schematic diagram of a vehicle communication system according to an embodiment of the present disclosure;

FIG. 3 shows a block diagram of a vehicle communication method according to an embodiment of the present disclosure;

FIG. 4 shows a flowchart of steps performed by a vehicle communication system according to an embodiment of the present disclosure;

FIG. 5 shows a flowchart of steps performed by a vehicle communication system according to an embodiment of the present disclosure;

FIG. 6 shows a flowchart of steps executed by a vehicle communication system according to an embodiment of the present disclosure;

FIG. 7 shows a flowchart of steps performed by a vehicle communication system according to an embodiment of the present disclosure; and

FIG. 8 shows a flowchart of steps performed by a vehicle communication system according to an embodiment of the present disclosure.

### DETAILED DESCRIPTION

The embodiments of the present disclosure are described below. However, it should be understood that the disclosed embodiments are merely examples, and other embodiments may take various alternative forms. The drawings are not necessarily drawn to scale; some functions may be exaggerated or minimized to show details of specific components. Therefore, the specific structural and functional details disclosed herein should not be construed as restrictive, but merely serve as a representative basis for teaching those skilled in the art to use the present disclosure in various ways. As those of ordinary skill in the art will understand, the various features shown and described with reference to any one drawing can be combined with the features shown in one or more other drawings to produce embodiments that are not explicitly shown or described. The combinations of features shown provide representative embodiments for typical applications. However, various combinations and modifications to features consistent with the teachings of the present disclosure may be desirable for certain specific applications or implementations.

In this application, when an element or a part is referred to as being “on”, “joined to”, “connected to” or “coupled to” another element or part, the element or part may be directly on another element or part, joined, connected or coupled to another element or part, or there may be intervening elements or parts. In contrast, when an element is referred to as being “directly on”, “directly joined to”, “directly connected to” or “directly coupled to” another element or part, there may be no intervening elements or parts. Other words used to describe the relationship between elements should be interpreted in a similar manner.

As mentioned in the background above, the inventors recognize that in the current communication solutions between Internet of Things devices and vehicles, many of them are aimed at obtaining information in the houses through vehicles or instructing Internet of Things devices in the houses to perform corresponding operations, and rarely involve how to conveniently obtain the corresponding vehicle information without causing excessive interference to the driving driver. In fact, such application scenarios may occur frequently. For example, a busy owner at home wants to know where the vehicle of a visiting friend or mate on the way home is currently and when it can arrive in order to arrange time. In the current solutions, communication by telephone is required in this case, but this usually requires the driver to be distracted to answer. In view of these problems in the prior art, the inventors of the present disclosure propose a vehicle communication system and a corresponding method in one or more embodiments, and believe that they can solve one or more problems in the prior art.

The vehicle 105 involved in the following embodiments may be a standard gasoline-powered vehicle, a hybrid vehicle, a diesel-powered vehicle, and/or any other type of vehicle, and may also be a bus, a ship, or an aircraft. The Vehicle includes components related to mobility, such as an engine, an electric motor, a transmission, a suspension, a drive shaft, and/or wheels and so on. The vehicle can be non-autonomous, semi-autonomous (for example, some conventional motion functions are controlled by the vehicle) or autonomous (for example, the motion functions are controlled by the vehicle without direct input from a driver).

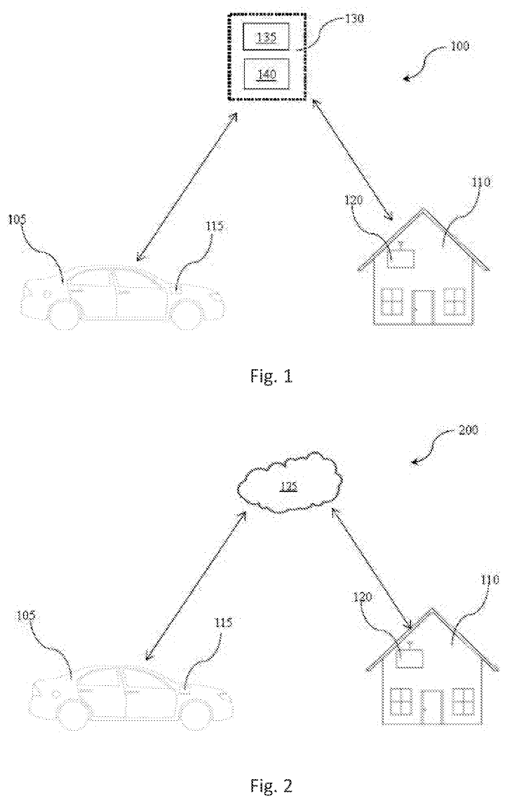

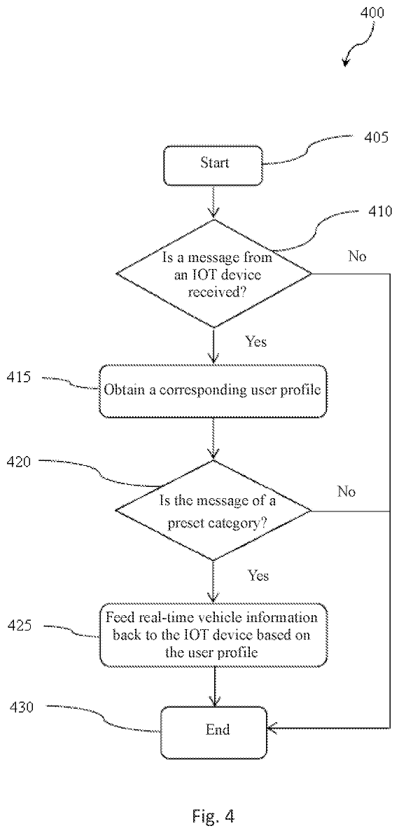

According to an aspect of the present disclosure, referring to FIGS. 1 and 4, a vehicle communication system 100 is provided, which comprises an information processing device 130. The information processing device 130 includes a processor 135 and a memory 140. The memory 140 stores instructions executable by the processor, that, when executed by the processor 135, cause the processor to perform steps comprising: in response to reception of a message sent by an Internet of Things device 120, determining category of the message and obtaining a corresponding user profile; and in response to the message being of a preset category, feeding real-time vehicle information back to the Internet of Things device 120 based on the user profile.

The Internet of Things device 120 generally refers to any device connected by the Internet of Things (IOT). The Internet of Things refers to a network that connects any device to the Internet through information sensing devices, such as radio frequency identification (RFID), infrared sensors, global positioning systems, laser scanners, etc., according to an agreed protocol for information exchange and communication, so as to realize intelligent identification, positioning, tracking, monitoring, communication and management. The Internet of Things device 120 is, for example, but not limited to, smart speaker, smart home appliance, smart camera, smart switch, smart door lock, and so on. In addition, in the context of the present disclosure, the Internet of Things device 120 usually includes an input device for receiving input such as voice, text, and the like. It should be noted that although the Internet of Things device 120 is often indoors, this is not intended to be limiting, and the Internet of Things device 120 can also be outdoors or operated outdoors. Those skilled in the art can understand that the concept of the present disclosure can be applied to a situation where the Internet of Things device 120 is in different indoor or outdoor locations.

The Internet of Things device 120, the information processing device 130, a cloud server 125, the vehicle 105, etc. can communicate through various communication technologies, including but not limited to cellular networks (for example, Global Mobile Communications (GSM), General Packet Radio Service (GPRS), Long Term Evolution (LTE), Third Generation Mobile Communication Technology (3G), Fourth Generation Mobile Communication Technology (4G), Fifth Generation Mobile Communication Technology (5G), Code Division Multiple Access (CDMA), etc.), 802.11 network (for example, WiFi), WiMax network, and/or satellite network. Correspondingly, the Internet of Things device 120, the information processing device 130, the cloud server 125, and the vehicle 105 may each include a mobile communication unit that performs wireless communication through the above-mentioned technology.

In the concept of the present disclosure, the information processing device 130 may be an independent entity or incorporated into various existing devices or systems. For example, the information processing device 130 may be a cloud server 125 or a part thereof, or a networked mobile device of a car owner or a part thereof, or a vehicle computer 115 of the vehicle 105 or a part thereof. Within the scope of the present disclosure, the location of the information processing device 130 can be set accordingly as needed.

The processor 135 can be any custom or commercially available processor, including a semiconductor-based microprocessor (in the form of a microchip or chipset), other types of microprocessors, or any device generally used to execute software instructions. The memory 140 may include any one or combination of volatile memory elements (for example, random access memory (RAM, such as dynamic random access memory (DRAM), static random access memory (SRAM), synchronous dynamic random access memory (SDRAM), etc.)) and non-volatile memory elements (for example, read only memory (ROM), hard drive, magnetic tape, CD-ROM, etc.). In addition, the memory 140 may include electronic, magnetic, optical, and/or other types of storage media. The memory 140 is configured to store software information used to implement the vehicle communication system and/or the technology described in the present disclosure.

The concept of the present disclosure is further explained below in conjunction with FIG. 4, which shows a flowchart of steps performed by the vehicle communication system 100 according to an embodiment of the present disclosure.

The process 400 starts at block 405. The initial step can occur at any time. According to some embodiments of the present disclosure, the initial step may occur when the vehicle 105 is traveling.

Subsequently, the process 400 proceeds to block 410, where it is checked whether a message from the Internet of Things device 120 is received. The message from the Internet of Things device 120 may be, for example, a voice message, a text message, a video message, and so on. The message from the Internet of Things device 120 may contain identifiable information about the Internet of Things device 120 (such as a token) and identifiable information of the corresponding vehicle to be communicated or its driver (such as phone number, account number, license number, license plate number, etc.). For example, a person in a house can speak to the Internet of Things device 120, “where is Mike's vehicle now?”, and the Internet of Things device 120 can recognize keywords in the voice, such as “vehicle”, “where”, and “Mike”, etc., and then the identification information (such as contact information, license plate number, etc.) of Mike or his vehicle 105 that is matched in a address book is attached to the message and sent to and received by the information processing device 130.

If the result of the check in block 410 is no, the process 400 proceeds to block 430, where it ends.

If the result of the check in block 410 is yes, then the process 400 proceeds to block 415, where the user profile is obtained based on the message from the Internet of Things device 120. The information processing device 130 may match the corresponding specific user according to the identifiable information of the corresponding vehicle/vehicle driver contained in the message from the Internet of Things device 120 to obtain the corresponding user profile stored in advance.

According to some embodiments of the present disclosure, the user profile may include a set of user preferences input and saved by the corresponding user, in which, for example, corresponding settings are made for the reception of and response to messages from different Internet of Things devices, such as allowing reception, refusing reception, etc. Those skilled in the art can envisage that the user profile can be stored in different locations such as the information processing device 130, the vehicle computer 115, and/or the cloud as required.

Subsequently, the process 400 proceeds to a decision block 420, where it is determined whether the message from the Internet of Things device 120 is of a preset category. For example, the information processing device 130 may determine category of the message based on the keywords contained in the message, or determine the category based on the result of the classification performed by the Internet of Things device 120 contained in the message. For example, messages containing keywords such as location and arrival time can be classified into a vehicle information query categories; and messages containing questions to be answered by the driver can be classified into categories to be answered, and so on. For the messages classified into, for example, vehicle information query categories, the information processing device 130 may determine that they belong to the preset category.

If the result of the determination in block 420 is no, the process 400 proceeds to block 430, where it ends.

If the result of the determination in block 420 is yes, then the process 400 proceeds to block 425, where real-time vehicle information is fed back to the Internet of Things device 120 based on the user profile. For example, when the user profile of the corresponding vehicle or vehicle driver includes permission to share vehicle information with the Internet of Things device 120, the real-time vehicle information of the vehicle 105 may be fed back to the Internet of Things device 120. The real-time vehicle information fed back may include, for example, an estimated time-of-arrival obtained by analysing the GPS (Global Positioning System) location and driving speed of the vehicle 105, or include a dynamic picture or video sharing the real-time vehicle position with the Internet of Things device 120, and so on.

According to some embodiments of the present disclosure, feeding real-time vehicle information back to the Internet of Things device 120 based on the user profile further includes: retrieving and analysing current position, vehicle speed, regional traffic conditions, and usual schedule of the vehicle 105 to determine an estimated time-of-arrival of the vehicle; and feeding the estimated time-of-arrival back to the Internet of Things device 120. When the message from the Internet of Things device 120 is directed to ask about the time-of-arrival of current vehicle, a more accurate time-of-arrival estimation result can be obtained by analysing the GPS location, driving speed of the vehicle 105, regional traffic conditions, the map of the current area, the usual schedule, etc., and can be sent to the Internet of Things device 120 directly or after approval based on whether user permission is required. The solution of this embodiment can incorporate multiple factors into reference, which greatly increases the accuracy of the estimation result.

Subsequently, the process 400 may proceed to block 430, where it ends. It should be noted that the end shown in block 430 does not mean the complete end of the step, but only mean the end of this round. In some embodiments, the process 400 will return and continue to monitor the aforementioned message.

Further, according to a further embodiment of the present disclosure, feeding real-time vehicle information back to the Internet of Things device 120 based on the user profile further includes: in response to inclusion of asking permission before feeding back in the user profile, asking the driver whether he agrees to feed the real-time vehicle information back to Internet of Things device 120; and if the driver agrees, feeding the real-time vehicle information back to the Internet of Things device 120. In this embodiment, it is possible to feed back the real-time vehicle information to the Internet of Things device 120 through simple interactions, while taking into account the personal privacy requirements of the vehicle driver.

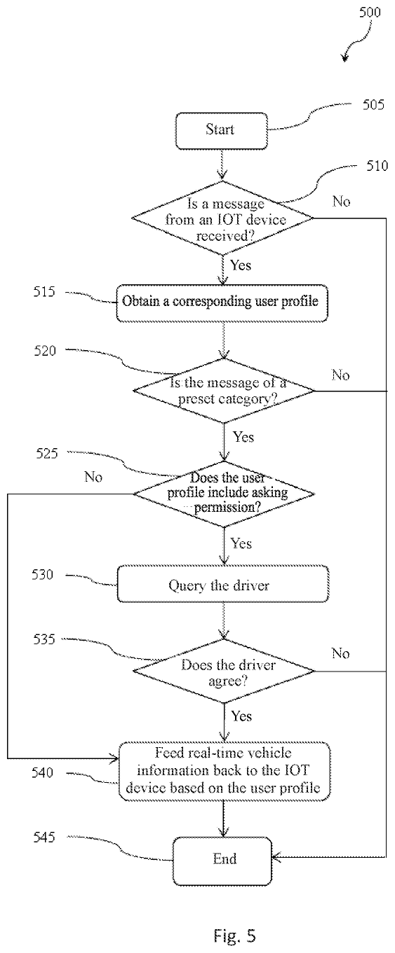

The further implementation is described below in conjunction with FIG. 5, which shows a flowchart of steps performed by the vehicle communication system 100 according to an embodiment of the present disclosure.

The blocks 505 to 520 in the process 500 substantially correspond to the blocks 405 to 420 in the process 400, and for the sake of brevity, details are not repeated here.

If the result of the determination in block 520 is yes, the process 500 proceeds to the next decision block 525, where it is determined whether the user profile includes settings for asking permission before feeding back. For example, the determination may be made by the information processing device 130 after analysing the user profile.

If the result of the determination in block 520 is yes, a query, such as a voice query, is issued to the driver in block 530. For example, the information processing device 130 can issue a voice query to the driver through the microphone of the vehicle computer 115, “Sally wants to know when you arrive at the house, is it allowed?” Of course, those skilled in the art can understand that the query can also contain text or graphics.

Subsequently, the process 500 proceeds to a decision block 535, where it is determined whether a positive answer from the driver is received. For example, after receiving the aforementioned message, the driver can simply answer “Yes” or “no” to respond. This will not affect the driving safety of the driver, while taking into account the needs for privacy protection.

If the result of the determination in block 535 is yes, then the real-time vehicle information is fed back to the Internet of Things device 120 in block 540.

If the result of the determination in block 535 is no, that is, the user profile includes settings for feeding back real-time vehicle information without the driver's permission, the process 500 proceeds directly from block 525 to block 540, where the real-time vehicle information is fed back to the Internet of Things device 120.

Subsequently, the process 500 may proceed to block 545, where it ends. Also as mentioned above, the end shown in block 545 does not mean the complete end of the step, but only mean the end of this round.

Further, according to a further embodiment of the present disclosure, feeding the real-time vehicle information back to the Internet of Things device 120 based on the user profile further includes: in response to designation of a number of trusted devices in the user profile, determining whether the Internet of Things device 120 belongs to a trusted device; and if the Internet of Things device 120 belongs to the trusted device, directly feeding the real-time vehicle information back to the Internet of Things device 120. By adding certain devices to the trusted device list, this solution can further reduce the number of links in user interaction and improve user satisfaction.

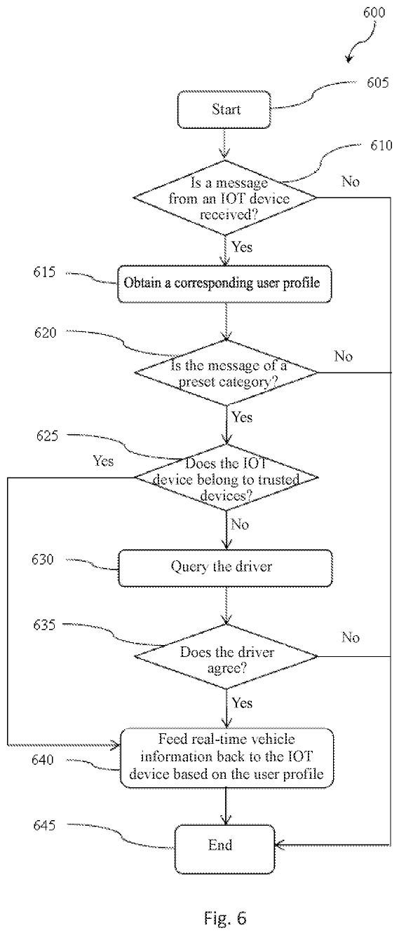

The further implementation is described below in conjunction with FIG. 6, which shows a flowchart of steps performed by the vehicle communication system 100 according to an embodiment of the present disclosure.

The blocks 605 to 620 in the process 600 substantially correspond to the blocks 405 to 420 in the process 400, and for the sake of brevity, details are not repeated here.

If the result of the determination in block 620 is yes, the process 600 proceeds to the next decision block 625, where it is determined whether the Internet of Things device 120 belongs to a trusted device. For example, the determination can be made by the information processing device 130 after analysing the user profile. For example, a list of trusted devices pre-input by the user may be included in the user profile and matched based on the identifiable information about the Internet of Things device 120 contained in the message. If the identifiable information exists in the list of the trusted devices, the Internet of Things device 120 is judged to be the trusted device.

If the result of the determination in block 625 is yes, then the process 600 proceeds to block 640, where the real-time vehicle information is fed back to the Internet of Things device 120.

According to some embodiments (the branch is not drawn in FIG. 6), if the result of the determination in block 625 is no, the process 600 may proceed to block 645, where it ends.

In contrast, according to other embodiments of the present disclosure, the foregoing steps further include: if the Internet of Things device 120 does not belong to the trusted device, asking the driver whether he agrees to feed the real-time vehicle information back to the Internet of Things device 120; and if the driver agrees, feeding the real-time vehicle information back to the Internet of Things device 120. The solution of this embodiment can reduce the number of interaction links while avoiding missing possible related information, thereby ensuring the effectiveness of the interaction.

Regarding this embodiment, referring to FIG. 6 again, if the result of the determination in block 625 is no, a query, such as a voice query, is issued by the information processing device 130 to the driver through, for example, the vehicle computer 115, in block 630.

Subsequently, the process 600 proceeds to a decision block 635, where it is determined whether a positive answer from the driver, such as a voice response, is received.

If the result of the determination in block 635 is yes, then the real-time vehicle information is fed back to the Internet of Things device 120 in block 640. If the result of the determination in block 635 is no, the process 600 may proceed to block 645, where it ends.

After block 640, the process 600 may proceed to block 645, where it ends. Also as mentioned above, the end shown in block 645 does not mean the complete end of the step, but only mean the end of this round.

According to some other embodiments of the present disclosure, the foregoing steps further include: in response to the message being a voice message, asking the driver whether to listen to the message; and if the driver confirms to listen to the message, playing the message to the driver. In the case that the message sent by the Internet of Things device 120 is a voice message, that is, it needs to be listened to and answered, the driver can decide whether to listen to and play the message according to the current driving situation, such as whether the traffic situation is complicated, and whether it is necessary to concentrate on handling the driving of the vehicle. This can reduce the interference to the driver and further improve driving safety.

Further, according to some other embodiments of the present disclosure, the foregoing steps further include: In response to reception of the message sent by the Internet of Things device, confirming the connection status of the vehicle; and in response to confirmation that the vehicle is not connected, retaining the message and forwarding the message to the vehicle the next time the vehicle is connected. This implementation can guarantee the delivery rate of the messages and ensure that the driver will not miss any useful messages.

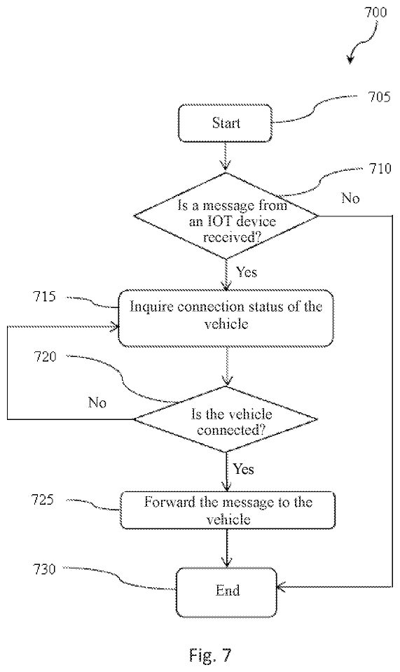

The further implementation is described below in conjunction with FIG. 7, which shows a flowchart of steps performed by the vehicle communication system 100 according to an embodiment of the present disclosure.

The blocks 705 to 710 in the process 700 substantially correspond to the blocks 405 to 410 in the process 400, and for the sake of brevity, the details are not repeated here.

After block 710, the process 700 proceeds to block 715, where the connection status of the vehicle 105 or the vehicle computer 115 is inquired, for example, whether the vehicle 105 or the vehicle computer 115 is connected to the information processing device 130 or the cloud server 125. It should be noted that only in this embodiment, the information processing device 130 is independent of the vehicle. For example, the information processing device 130 may be a mobile device of the driver or a part thereof, or a cloud server 125 or a part thereof.

Subsequently, the process 700 proceeds to a decision block 720, where it is determined whether the vehicle 105 or the vehicle computer 115 is connected based on the result of the inquiry. If the result of the determination in block 720 is no, the process 700 returns to the block 715 and continues to inquire the connection status of the vehicle 105 or the vehicle computer 115.

According to some embodiments of the present disclosure, the foregoing steps further include: sending a notification to the Internet of Things device 120 in response to confirmation that the vehicle 105 is not connected. For example, when returning from block 720 to block 715 for the first time, a notification message is sent to the Internet of Things device 120 that the vehicle 105 or the vehicle computer 115 is not connected. The solution of this embodiment can enable the owner of the Internet of Things device 120 to know the fact that the vehicle 105 or the vehicle computer 115 is not connected in time, and switch to other communication channels in time if necessary, thus ensuring the efficiency of communication.

If the result of the determination in block 720 is yes, the process 700 proceeds to a block 725, whom the message is sent to the vehicle.

After block 725, the process 700 may proceed to block 730, where it ends. Also as mentioned above, the end shown at block 730 does not mean the complete end of the step, but only mean the end of this round.

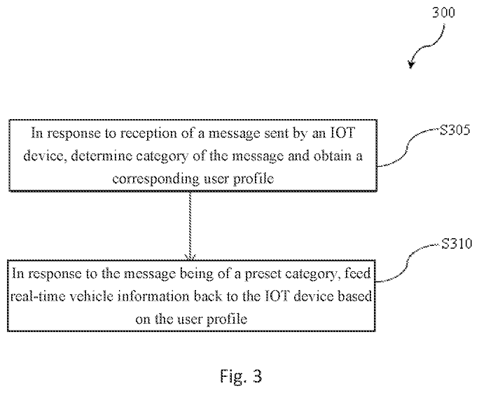

According to another aspect of the present disclosure, referring to FIG. 3, a vehicle communication method S300 is also provided, which comprising: S305 in response to reception of a message sent by an Internet of Things device 120, determining the category of the message and obtaining a corresponding user profile; and S310 in response to the message being of a preset category, feeding real-time vehicle information back to the Internet of Things device 120 based on the user profile. It should be understood that all the embodiments, features and advantages described above for the vehicle communication system 100 according to the present disclosure are equally applicable to the method according to the present disclosure, provided that they do not conflict with each other. That is to say, all the above-mentioned embodiments and their variants for the vehicle communication system 100 can be directly transferred to the method according to the present disclosure, and directly combined with this. For the sake of brevity of the present disclosure, the description will not be repeated here.

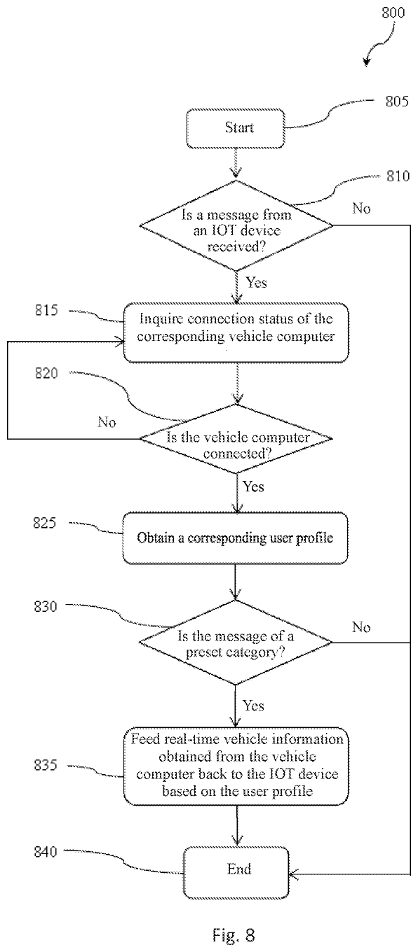

According to another aspect of the present disclosure, referring to FIGS. 2 and 8, a vehicle communication system 200 is provided, which comprising: an Internet of Things device 120; a vehicle computer 115; and a cloud server 125. The cloud server 125 includes a processor and a memory. The memory stores instructions executable by the processor, that, when executed by the processor, cause the processor to perform steps comprising: in response to reception of a message sent by the Internet of Things device 120, determining the category of the message and the connection status of the corresponding vehicle computer 115 and obtaining a corresponding user profile; and in response to the connection status being connected status and the message being of a preset category, feeding real-time vehicle information obtained from the vehicle computer 115 back to the Internet of Things device 120 based on the user profile. The difference from the aforementioned vehicle communication system 100 is that the information processing device 130 is specifically incorporated into a cloud server in the vehicle communication system 200. Based on this solution, the concept of the present disclosure can be executed with fewer resources.

Referring now to FIG. 8, there is shown a flowchart of the steps performed by the vehicle communication system 200.

The blocks 805 to 810 in the process 800 substantially correspond to the blocks 405 to 410 in the process 400, and for the sake of brevity, the details are not repeated here.

After block 810, the process 800 proceeds to block 815, where the connection status of the vehicle computer 115 is inquired, that is, whether the vehicle computer 115 is connected to the cloud server 125.

Subsequently, the process 800 proceeds to a decision block 820, where it is determined whether the vehicle computer 115 is connected based on the result of the inquiry. If the result of the determination in block 820 is no, the process 800 returns to the block 815 and continues to inquire the connection status of the vehicle computer 115.

If the result of the determination in block 820 is yes, then the process 800 proceeds to block 825, whom the user profile is obtained based on the message from the Internet of Things device 120.

Subsequently, the process 800 proceeds to a decision block 830, where it is determined whether the message from the Internet of Things device 120 is of a preset category.

If the result of the determination in block 830 is no, the process 800 proceeds to block 840, where it ends.

If the result of the determination in block 830 is yes, then the process 800 proceeds to block 835, where the real-time vehicle information obtained from the vehicle computer 115 is fed back to the Internet of Things device 120 based on the user profile.

Subsequently, the process 800 may proceed to block 840, where it ends. As mentioned above, the end shown in block 840 does not mean the complete end of the step, but only mean the end of this round.

Likewise, all the embodiments, features and advantages explained above for the vehicle communication system 100 according to the present disclosure are equally applicable to the vehicle communication system 200 according to the present disclosure. That is to say, all the above-mentioned embodiments and their variants for the vehicle communication system 100 can be directly transferred to the vehicle communication system 200 according to the present disclosure, and directly combined with this. For the sake of brevity of the present disclosure, the description will not be repeated here.

In summary, compared with the prior art, the present disclosure proposes a vehicle communication system and a corresponding method which can enable an Internet of Things device, such as those in a house, to send a request to the vehicle and conveniently obtain the corresponding vehicle information without causing excessive interference to the driving driver.

Where it is technically possible, the technical features listed in relation to different embodiments can be combined with each other to form further embodiment within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The term “including” is inclusive and has the same scope as “comprising”.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only illustrative, and is not intended to imply that the disclosed scope of the embodiments of the present disclosure (including claims) is limited to these examples; under the overall concept of the invention, the technical features in the above embodiments or different embodiments can be combined with each other to produce many other their variants in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

1. A vehicle communication system, comprising:
an information processing device including a processor and a memory, the memory storing instructions executable by the processor, that, when executed by the processor, cause the processor to perform steps comprising:
in response to reception of a message sent by an Internet of Things device, determining category of the message and obtaining a corresponding user profile; and
in response to the message being of a preset category, feeding real-time vehicle information back to the Internet of Things device based on the user profile.

2. The system according to claim 1, wherein feeding real-time vehicle information back to the Internet of Things device based on the user profile further comprises:
in response to inclusion of asking permission before feeding back in the user profile, asking a driver whether he agrees to feed the real-time vehicle information back to the Internet of Things device; and
if the driver agrees, feeding the real-time vehicle information back to the Internet of Things device.

3. The system according to claim 1, wherein feeding real-time vehicle information back to the Internet of Things device based on the user profile further comprises:
in response to designation of a number of trusted devices in the user profile, determining whether the Internet of Things device belongs to the trusted device; and
if the Internet of Things device belongs to the trusted device, directly feeding the real-time vehicle information back to the Internet of Things device.

4. The system according to claim 3, wherein the steps further comprise:
if the Internet of Things device does not belong to the trusted device, asking the driver whether he agrees to feed the real-time vehicle information back to the Internet of Things device; and
if the driver agrees, feeding the real-time vehicle information back to the Internet of Things device.

5. The system according to claim 1, wherein the steps further comprise:
in response to the message being a voice message, asking the driver whether to listen to the message; and
if the driver confirms to listen to the message, playing the message to the driver.

6. The system according to claim 1, wherein the steps further comprise:
in response to the reception of the message sent by an Internet of Things device, confirming connection status of the vehicle; and
in response to confirmation that the vehicle is not connected, retaining the message and forwarding the message to the vehicle the next time the vehicle is connected.

7. The system according to claim 6, wherein the steps further comprise:
in response to confirmation that the vehicle is not connected, sending a notification to the Internet of Things device.

8. The system according to claim 1, wherein feeding real-time vehicle information back to the Internet of Things device based on the user profile further comprises:
retrieving and analysing current location, speed, regional traffic conditions, and usual schedule of the vehicle to determine an estimated time-of-arrival of the vehicle; and
feeding the estimated time-of-arrival of the vehicle back to the Internet of Things device.

9. A vehicle communication method, comprising:
in response to reception of a message sent by the Internet of Things device, determining category of the message and obtaining a corresponding user profile; and
in response to the message being of a preset category, feeding real-time vehicle information back to the Internet of Things device based on the user profile.

10. The method according to claim 9, wherein feeding real-time vehicle information back to the Internet of Things device based on the user profile further comprises:
in response to inclusion of asking permission before feeding back in the user profile, asking a driver whether he agrees to feed the real-time vehicle information back to the Internet of Things device; and
if the driver agrees, feeding the real-time vehicle information back to the Internet of Things device.

11. The method according to claim 9, wherein feeding real-time vehicle information back to the Internet of Things device based on the user profile further comprises:
in response to designation of a number of trusted devices in the user profile, determining whether the Internet of Things device belongs to the trusted device; and
if the Internet of Things device belongs to the trusted device, directly feeding the real-time vehicle information back to the Internet of Things device.

12. The method according to claim 11, further comprising:
if the Internet of Things device does not belong to the trusted device, asking the driver whether he agrees to feed the real-time vehicle information back to the Internet of Things device; and
if the driver agrees, feeding the real-time vehicle information back to the Internet of Things device.

13. The method according to claim 9, further comprising:
In response to the message being a voice message, asking the driver whether to listen to the message; and
if the driver confirms to listen to the message, playing the message to the driver.

14. The method according to claim 9, wherein feeding real-time vehicle information back to the Internet of Things device based on the user profile further comprises:
retrieving and analysing current location, speed, regional traffic conditions, and usual schedule of the vehicle to determine an estimated time-of-arrival of the vehicle; and
feeding the estimated time-of-arrival of the vehicle back to the Internet of Things device.

15. A vehicle communication system, comprising:
an Internet of Things device;
a vehicle computer; and
a cloud server including a processor and a memory, the memory storing instructions executable by the processor, that, when executed by the processor, cause the processor to perform steps comprising:
in response to reception of a message sent by the Internet of Things device, determining category of the message and connection status of the corresponding vehicle computer and obtaining a corresponding user profile; and
in response to the connection status being connected status and the message being of a preset category, feeding real-time vehicle information obtained from the vehicle computer back to the Internet of Things device based on the user profile.

16. The system according to claim 15, wherein feeding real-time vehicle information obtained from the vehicle computer back to the Internet of Things device based on the user profile further comprises:
in response to inclusion of asking permission before feeding back in the user profile, asking the driver whether he agrees to feed the real-time vehicle information back to the Internet of Things device; and
if the driver agrees, feeding the real-time vehicle information back to the Internet of Things device.

17. The system according to claim 15, wherein feeding real-time vehicle information obtained from the vehicle computer back to the Internet of Things device based on user profile further comprises:
in response to designation of a number of trusted devices in the user profile, determining whether the Internet of Things device belongs to the trusted device; and
if the Internet of Things device belongs to the trusted device, directly feeding the real-time vehicle information back to the Internet of Things device.

18. The system according to claim 17, wherein the steps further comprise:
if the Internet of Things device does not belong to the trusted device, asking the driver whether he agrees to feed the real-time vehicle information back to the Internet of Things device; and
if the driver agrees, feeding the real-time vehicle information back to the Internet of Things device.

19. The system according to claim 15, wherein the steps further comprise:
in response to confirmation that the vehicle computer is not connected, retaining the message and forwarding the message to the vehicle computer the next time the vehicle computer is connected.

20. The system according to claim 15, wherein the steps further comprise:
in response to the message being a voice message, asking the driver whether to listen to the message; and
if the driver confirms to listen to the message, playing the message to the driver.
